(19) United States
(12) Patent Application Publication
(10) Pub. No.: US 2023/0007486 A1
(43) Pub. Date: Jan. 5, 2023

(54) SYSTEM AND METHOD OF NETWORKING SECURITY FOR VIRTUALIZED BASE STATION

(71) Applicant: CommScope Technologies LLC, Hickory, NC (US)

(72) Inventors: James J. Ni, Medford, MA (US); Shanthakumar Ramakrishnan, Westford, MA (US); Devaraj Sambandan, Bengaluru (IN); Sriram Dharwadkar, Bangalore (IN); Ehsan Daeipour, Southborough, MA (US)

(73) Assignee: CommScope Technologies LLC, Hickory, NC (US)

(21) Appl. No.: 17/855,355

(22) Filed: Jun. 30, 2022

(30) Foreign Application Priority Data
Jun. 30, 2021 (IN) 202141029386

(51) Int. Cl. H04W 12/088; H04L 12/66

(52) U.S. Cl. CPC H04W 12/088; H04L 12/66

(57) ABSTRACT

Systems and methods for implementing IPsec connections for one or more virtualized base station entities are provided.

### CROSS-REFERENCE TO RELATED APPLICATIONS

This application claims priority to IN Provisional Application No. 202141029386 filed on Jun. 30, 2021, and titled “SYSTEM AND METHOD OF NETWORKING SECURITY FOR VIRTUALIZED BASE STATION,” the contents of which are hereby incorporated by reference in their entirety.

### BACKGROUND

Cloud-based virtualization of Fifth Generation (5G) base stations (also referred to as “g NodeBs” or “gNBs”) is widely promoted by standards organizations, wireless network operators, and wireless equipment vendors. Such an approach can help provide better high-availability and scalability solutions as well as addressing other issues in the network.

FIG. 1 is a block diagram illustrating a typical 5G distributed gNB. In general, a distributed 5G gNB can be partitioned into different entities, each of which can be implemented in different ways. For example, each entity can be implemented as a physical network function (PNF) or a virtual network function (VNF) and in different locations within an operator's network (for example, in the operator's “edge cloud” or “central cloud”).

In the particular example shown in FIG. 1, a distributed 5G gNB 100 is partitioned into one or more central units (CUs) 102, one or more distributed units (DUs) 104, and one or more radio units (RUs) 106. In this example, each CU 102 is further partitioned into a central unit control-plane (CU-CP) 108 and one or more central unit user-planes (CU-UPs) 110 dealing with the gNB Packet Data Convergence Protocol (PDCP) and higher layers of functions of the respective control and user planes of the gNB 100. Each DU 104 is configured to implement the upper part of the physical layer through the radio link control (RLC) layer of both the control-plane and user-plane of the gNB 100. In this example, each RU 106 is configured to implement the radio frequency (RF) interface and lower physical layer control-plane and user-plane functions of the gNB 100.

Each RU 106 is typically implemented as a physical network function (PNF) and is deployed in a physical location where radio coverage is to be provided. Each DU 104 is typically implemented as a virtual network function (VNF) and, as the name implies, is typically distributed and deployed in a distributed manner in the operator's edge cloud. Each CU-CP 108 and CU-UP 110 are typically implemented as a virtual network functions (VNFs) and are typically centralized and deployed in the operator's central cloud.

When deploying a distributed gNB 100, operators have the option to deploy RUs 106, DUs 104, CU-CP 108, and CU-UPs 110 all in one trusted network or to deploy any one of the DUs 104, RUs 106, the CU-CP 108, and/or the CU-UPs 110 in an edge network, which is likely untrusted. In all deployment cases, there are additional features (for example, the management O1 connection inside/outside an operator's trusted networks, service orchestration virtual network management function (VNMF) inside/outside operators' trusted networks, virtual infrastructure management (VIM) function inside/outside operators' trusted network, etc.) that are utilized when implementing a virtualized gNB. The networking security in all deployment cases on various interfaces is a critical component of implementing a virtualized gNB.

### SUMMARY

In an example, a system to provide wireless service to user equipment comprises a scalable cloud environment configured to implement a base station using a plurality of virtualized base station entities, wherein each virtualized base station entity of the plurality of virtualized base station entities is configured to implement at least some functions for one or more layers of a wireless interface used to communicate with user equipment. The scalable cloud environment is also configured to implement a first Internet Protocol Security (IPsec) virtual gateway configured to be communicatively coupled to an external network. The first IPsec virtual gateway is configured to terminate an IPsec tunnel with the external network and route traffic from the external network to at least one application implemented by a first virtualized base station entity of the plurality of virtualized entities.

In another example, a server comprises an Internet Protocol Security (IPsec) virtual gateway configured to be communicatively coupled to an external network. The server further comprises at least one application virtual network function of a first virtualized base station entity. The at least one application virtual network function is communicatively coupled to the IPsec virtual gateway via an internal network, and the first virtualized base station entity is configured to implement at least some functions for one or more layers of a wireless interface used to communicate with user equipment. The IPsec virtual gateway is configured to terminate an IPsec tunnel with the external network and route traffic from the external network to the at least one application virtual network function of the first virtualized base station entity.

In another example, a method of providing wireless service to user equipment comprises using a scalable cloud environment configured to implement a base station using a plurality of virtualized entities, wherein each virtualized entity of the plurality of virtualized entities is configured to implement at least some functions for one or more layers of a wireless interface used to communicate with user equipment. The scalable cloud environment is further configured to implement a first Internet Protocol Security (IPsec) virtual gateway configured to be communicatively coupled to an external network. The first IPsec virtual gateway is configured to terminate an IPsec tunnel with the external network and route traffic from the external network to at least one application implemented by a first virtualized entity of the plurality of virtualized entities.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram illustrating a typical 5G distributed gNB;

FIG. 2 is a block diagram of an example virtualized 5G gNB;

FIG. 3 is a block diagram of example connections between nodes of a virtualized 5G gNB and an external network using an Internet Protocol Security (IPsec) virtual gateway;

FIG. 4 is a block diagram of example IPsec connections between a node of a virtualized 5G gNB and an external network;

FIGS. 5A-5B are block diagrams illustrating an example of outgoing and incoming traffic flows through an IPsec virtual gateway; and

FIG. 6 is a diagram of example implementation of a virtualized 5G gNB with various IPsec connections between nodes of the virtualized 5G gNB and external networks.

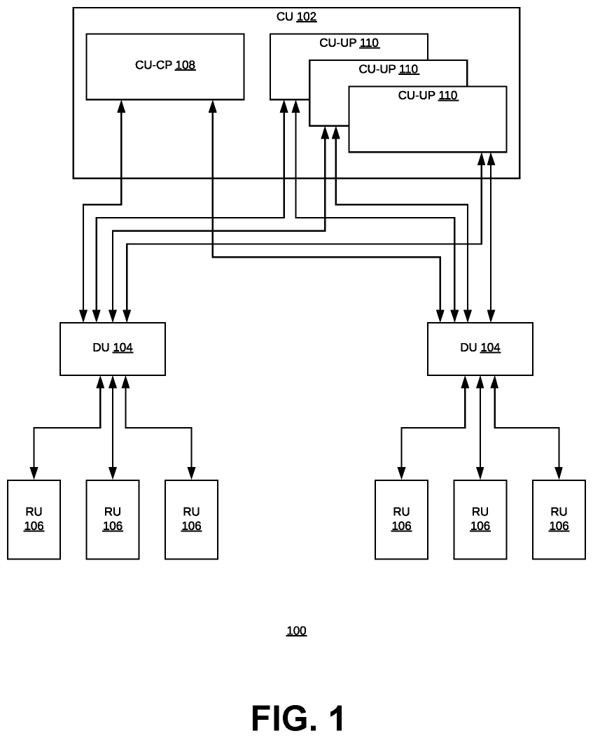

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. The following detailed description is, therefore, not to be taken in a limiting sense.

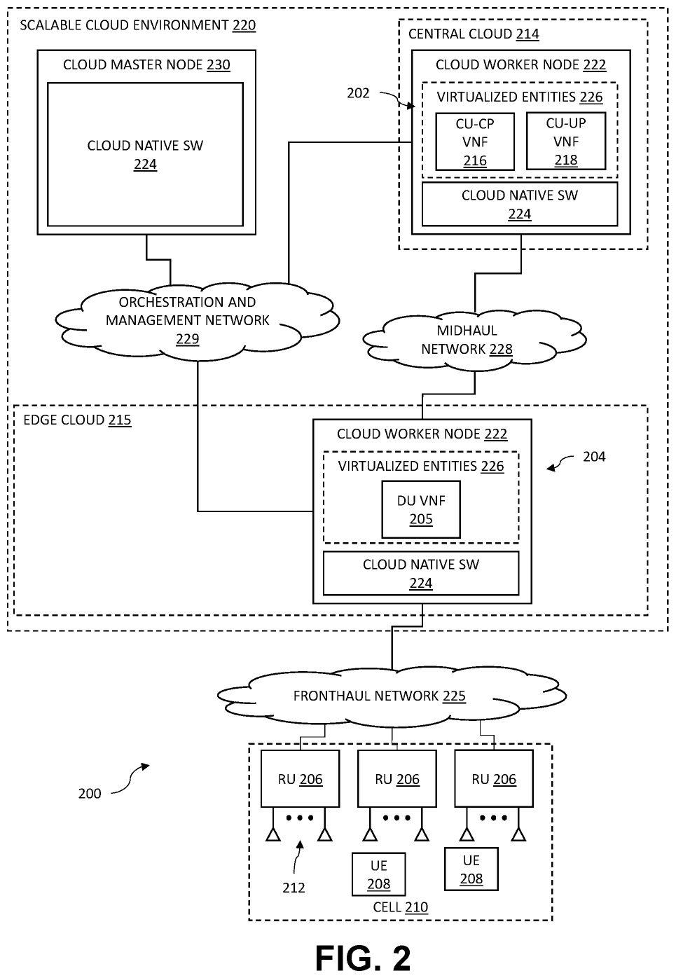

FIG. 2 is a block diagram illustrating one example of a virtualized 5G gNB 200 in which the networking security techniques described here can be used. In the particular example shown in FIG. 2, the virtualized 5G gNB 200 is partitioned into one or more central units (CUs) 202, which is composed of one central unit control-plane (CU-CP) virtual network function 216 and one or more central unit user-plane (CU-UP) virtual network functions 218, one or more distributed units (DUs) 204, which is composed of one or more DU virtual network functions 205, and one or more radio units (RUs) 206. In this example the virtualized 5G gNB 200 is configured so that each CU 202 is configured to serve one or more DUs 204 and each DU 204 is configured to serve one or more RUs 206. In the particular configuration shown in FIG. 2, a single CU 202 serves a single DU 204, and the DU 204 shown in FIG. 2 serves three RUs 206. However, the particular configuration shown in FIG. 2 is only one example; other numbers of CUs 202, DUs 204, and RUs 206 can be used. Also, the number of DUs 204 served by each CU 202 can vary from CU 202 to CU 202; likewise, the number of RUs 206 served by each DU can vary from DU 204 to DU 204. Moreover, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future) and the following description is not intended to be limited to any particular mode. Also, unless explicitly indicated to the contrary, references to “layers” or a “layer” (for example, Layer 1, Layer 2, Layer 3, the Physical Layer, the MAC Layer, etc.) set forth herein refer to layers of the wireless interface (for example, 5G NR or 4G LTE) used for wireless communication between a base station and user equipment).

In general, the virtualized gNB 200 is configured to provide wireless service to various numbers of user equipment (UEs) 208 using one or more cells 210 (only one of which is shown in FIG. 2 for ease of illustration). Each RU 206 includes or is coupled to a respective set of one or more antennas 212 via which downlink RF signals are radiated to UEs 208 and via which uplink RF signals transmitted by UEs 208 are received.

In one configuration (used, for example, in indoor deployments), each RU 206 is co-located with its respective set of antennas 212 and is remotely located from the DU 204 and CU 202 serving it as well as the other RUs 206. In another configuration (used, for example, in outdoor deployments), the respective sets of antennas 212 for multiple RUs 206 are deployed together in a sectorized configuration (for example, mounted at the top of a tower or mast), with each set of antennas 212 serving a different sector. In such a sectorized configuration, the RUs 206 need not be co-located with the respective sets of antennas 212 and, for example, can be co-located together (for example, at the base of the tower or mast structure) and, possibly, co-located with its serving DUs 204. Other configurations can be used.

The virtualized gNB 200 is implemented using a scalable cloud environment 220 in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment 220 can be implemented in various ways. For example, the scalable cloud environment 220 can be implemented using hardware virtualization, operating system virtualization, and application virtualization (also referred to as containerization) as well as various combinations of two or more of the preceding. The scalable cloud environment 220 can be implemented in other ways. For example, as shown in FIG. 2, the scalable cloud environment 220 is implemented in a distributed manner. That is, the scalable cloud environment 220 is implemented as a distributed scalable cloud environment 220 comprising at least one central cloud 214 and at least one edge cloud 215.

In the example shown in FIG. 2, each RU 206 is implemented as a physical network function (PNF) and is deployed in or near a physical location where radio coverage is to be provided. In this example, each DU 204 is implemented with one or more DU virtual network functions (VNFs) 205 and, as the name implies, is distributed and deployed in a distributed manner in the edge cloud 215. Each CU-CP is implemented with a CU-CP VNF 216 and each CU-UP is implemented with a CU-UP VNF 218 and, as the name implies, are centralized and deployed in the central cloud 214. In the example shown in FIG. 2, the CU 202 (including the CU-CP VNF 216 and CU-UP VNF 218) and the entities used to implement it are communicatively coupled to each DU 204 served by the CU 202 (and the DU VNF(s) 205 used to implement each such DU 204) over a midhaul network 228 (for example, a network that supports the Internet Protocol (IP)). In the example shown in FIG. 2, each DU 204, and the DU VNF(s) 205 used to implement it, are communicatively coupled to each RU 206 served by the DU 204 using a fronthaul network 225 (for example, a switched Ethernet network that supports the IP).

As shown in FIG. 2, the scalable cloud environment 220 comprises one or more cloud worker nodes 222 that are configured to execute cloud native software 224 that, in turn, is configured to instantiate, delete, communicate with, and manage one or more virtualized entities 226. For example, where the networking security techniques described here are implemented at the operating system virtualization level, each cloud worker node 222 comprises one or more virtualized entities 226 and a cloud native software 224, the cloud native software 224 comprises a shared host operating system, and the virtualized entities 226 comprise one or more virtual network functions (VNFs), and each VNF further comprises one or more functional containers. In another example, where the networking security techniques described here are implemented at the hardware virtualization level, the cloud worker nodes 222 comprise respective clusters of physical worker nodes, the cloud native software 224 comprises a hypervisor (or similar software), and the virtualized entities 226 comprise virtual machines.

In the example shown in FIG. 2, a node of the scalable cloud environment 220 is designated as the cloud “master” node 230. The cloud master node 230 is configured to implement management and orchestration processes for the worker nodes 222 in a cluster and the cloud master node 230 is communicatively coupled to the worker nodes 222 via an orchestration and management network 229. In some examples, the cloud master node 230 is configured to determine what runs on each of the cloud worker nodes 222, which can include scheduling, resource allocation, state maintenance, and monitoring. In some examples, the cloud master node is configured to manage the lifecycle, scaling, and upgrades of workloads (such as containerized applications) on the cloud worker nodes 222.

In the example shown in FIG. 2, each DU VNF 205, CU-CP VNF 216, and CU-UP VNF 218 is implemented as a software virtualized entity 226 that is executed in the scalable cloud environment 220 on a cloud worker node 222 under the control of the cloud native software 224 executing on that cloud worker node 222. In the following description, a cloud worker node 222 that implements at least a part of a CU 202 (for example, a CU-CP VNF 216 and/or a CU-UP VNF 218) is also referred to here as a “CU cloud worker node” 222, and a cloud worker node 222 that implements at least a part of a DU 204 is also referred to here as a “DU cloud worker node” 222.

In the example shown in FIG. 2, the CU-CP VNF 216 and the CU-UP VNF 218 are each implemented as a single virtualized entity 226 executing on the same cloud worker node 222. In the example shown in FIG. 2, the DU VNF 205 is implemented as a single virtualized entity 226 executing on the same cloud worker node 222. However, it is to be understood that this is just one example and that different configurations and examples can be implemented in other ways. For example, the CU 202 can be implemented using multiple CU-UP VNFs 218 using multiple virtualized entities 226 executing on one or more cloud worker nodes 222. In another example, multiple DU VNFs 205 (using multiple virtualized entities 226 executing on one or more cloud worker nodes 222) can be used to serve a cell, where each of the multiple DU VNFs 205 serves a different set of RUs 206. Moreover, it is to be understood that the CU 202 and DU 204 can be implemented in the same cloud (for example, together in an edge cloud 215). Other configurations and examples can be implemented in other ways.

Bringing a virtualized gNB (such as virtualized gNB 200) up to service is generally performed in multiple stages by a variety of entities. The virtualization infrastructure/environment required for gNB VNFs is brought up from bare metal servers and relevant network and storage equipment (for example, using platform orchestration through an edge cloud node management network or controller). The gNB VNFs are then deployed and orchestrated into service providing entities (for example, using service orchestration through a virtual network function manager (VNFM)). The gNB VNFs are also configured and activated to make them service ready (for example, using service configuration with an Operations and Maintenance (OAM) entity or Device Management System (DMS)). The gNB VNFs will be communicatively coupled to many other components in different networks, which can include but are not limited to a platform orchestration network, a service orchestration network, a service management network, a mobile network (for example, an operator's mobile infrastructure including LTE/5G core and access networks), and a time service network (for example, 1588 traffic used for synchronization).

When deploying and managing gNB VNFs, the location of the network elements determines the different networking and security requirements. When the virtual network functions (VNFs) used to implement a virtualized gNB are outside a trusted network (for example, outside the operator's mobile core network), the tunnel mode of Internet Protocol Security (IPsec) can generally be used between the VNF and each trusted network that communicates data with the VNF. In many situations, the number of IPsec tunnels connected to a mobile core operator's network is limited by an operator in order to reduce the exposure or vulnerability of the operator network because more IPsec tunnels generally increase the vulnerability of a network. The number of IPsec tunnels connected to a mobile core operator's network can also be limited by operator IPsec resource availability or operator network topology restrictions. If each IPsec tunnel is terminated by the relevant VNF, a prohibitively large amount of IPsec tunnels could be required to implement a distributed deployment (such as a deployment shown in and described with respect to FIG. 2).

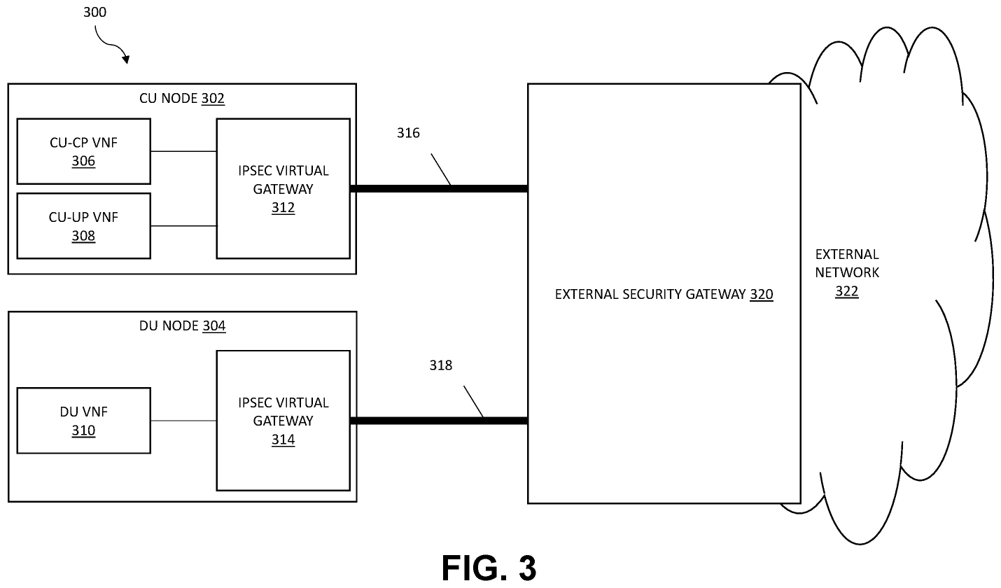

FIG. 3 illustrates a block diagram of example connections between nodes of a virtualized gNB and an external network. In the example shown in FIG. 3, two different nodes of the gNB, the CU node 302 and the DU node 304, are communicatively coupled to an external network 322. While FIG. 3 specifically illustrates the CU node 302 and DU node 304 of a virtualized gNB, it should be understood that the techniques described with respect to these features can also be implemented for any virtualized base station entity used to implement at least some functions for one or more layers of a wireless interface used to communicate with user equipment. While not explicitly shown in FIG. 3 for clarity, it should be understood that the CU node 302 and the DU node 304 of the virtualized gNB in FIG. 3 can be implemented using the scalable cloud platform and virtualization techniques described above. Further, while FIG. 3 illustrates VNFs specific to the CU node 302 (CU-CP VNF 306 and CU-UP VNF 308) and the DU node 304 (DU VNF 310), it should be understood that the techniques described with respect to these features can also be implemented for other applications or VNFs implemented by a virtualized base station entity used to implement at least some functions for one or more layers of a wireless interface used to communicate with user equipment.

In the example shown in FIG. 3, the CU node 302 includes a CU-CP VNF 306 and a CU-UP VNF 308 coupled to a first IPsec virtual gateway 312. The first IPsec virtual gateway 312 is communicatively coupled to an external security gateway 320 of a network 322 (for example, a service management network such as an OAM network). For incoming traffic, the first IPsec virtual gateway 312 is configured to terminate the IPsec tunnel 316 between the CU node 302 and the external security gateway 320 (including removing encapsulation) and to route the traffic to the addressed terminating VNFs (CU-CP VNF 306 and CU-UP VNF 308) accordingly. For outgoing traffic, the first IPsec virtual gateway 312 is configured to encapsulate the packets from the VNFs (CU-CP VNF 306 and CU-UP VNF 308) inside the IPsec tunnel IP packets and transmit the IPsec tunnel IP packets to the external security gateway 320 via an IPsec tunnel 316. The first IPsec virtual gateway 312 is configured to connect with the external security gateway 320 in a peer-to-peer mode (for example, gateway-to-gateway).

In the example shown in FIG. 3, the DU node 304 includes a DU VNF 310 coupled to a second IPsec virtual gateway 314. The second IPsec virtual gateway 314 is communicatively coupled to an external security gateway 320 of a network 322 (for example, a service management network such as an OAM network). For incoming traffic, the second IPsec virtual gateway 314 is configured to terminate the IPsec tunnel 318 between the DU node 304 and the external security gateway 320 (including removing encapsulation) and to route the traffic to the addressed terminating VNF (DU VNF 310). For outgoing traffic, the second IPsec virtual gateway 314 is configured to encapsulate the packets from the VNFs (DU VNF 310) inside the IPsec tunnel IP packets and transmit the IPsec tunnel IP packets to the external security gateway 320 via the IPsec tunnel 318. The second IPsec virtual gateway 314 is configured to connect with the external security gateway 320 in a peer-to-peer mode (for example, gateway-to-gateway).

The CU-CP VNF 306, CU-UP VNF 308, and DU VNF 310 are separate network elements and treated as physical entities from a network point of view. In the example shown in FIG. 3, the CU node 302 and the DU node 304 of the virtualized gNB each include an internal IP subnetwork that is exposed through the respective IPsec virtual gateway 312, 314. In some examples, the IPsec virtual gateway 312, 314 and each of the VNFs 306, 308, 310 in a particular node are deployed as a microservice that has its own unique identity and IP address (used as an inner IP address for IPsec tunnel traffic). In such examples, the respective IPsec virtual gateway 312, 314 exposes the IP addresses and identities of the elements for the internal subnetwork of the node to the external network 322 in a manner similar to a site-to-site VPN model, and the external network 322 is able to communicate with each VNF 306, 308, 310 of a node individually using the unique IP address for the respective VNF 306, 308, 310.

In some examples, each node has a respective IP subnetwork for each type of traffic where an IPsec connection is used. In such examples, each VNF 306, 308, 310 is assigned a respective IP address for each type of traffic that is communicated to/from that VNF 306, 308, 310, which is used as an inner IP address for each type of traffic transmitted through an IPsec tunnel.

In some such examples, when an IPsec virtual gateway 312, 314 is used to connect the VNF 306, 308, 310 to an external network 322 via an IPsec tunnel, the IPsec virtual gateway 312, 314 is assigned an IPv6 address as the gateway IP address of the subnetwork serving the VNFs 306, 308, 310 and an IPv4 address (used as an outer IP address for IPsec tunnel traffic) for the tunnel network interface communicatively coupled to the external network security gateway 320, and the VNFs 306, 308, 310 are each assigned an IPv6 address (used as an inner source IP address of each of the VNFs traffic to be encapsulated inside the IPsec tunnel traffic) for the VNF network interface communicatively coupled to the IPsec virtual gateway 312, 314. The first IPsec virtual gateway 312 is configured to route traffic to/from the CU-CP VNF 306 and the CU-UP VNF 308 using the IPv6 address for the CU-CP VNF 306 and the CU-UP VNF 308, and the second IPsec virtual gateway 314 is configured to route traffic to/from the DU VNF 310 using the IPv6 address for the DU VNF 310.

In other examples, when an IPsec virtual gateway 312, 314 is used to connect the VNF 306, 308, 310 to an external network 322, the IPsec virtual gateway 312, 314 is assigned an IPv4 address as the gateway IP address of the subnetwork serving the VNFs 306, 308, 310 and an IPv6 address (used as an outer IP address for IPsec tunnel traffic) for the tunnel network interface communicatively coupled to the external network security gateway 320, and the VNFs 306, 308, 310 are each assigned an IPv4 address (used as an inner source IP address of each of the VNFs traffic to be encapsulated inside the IPsec tunnel traffic) for the VNF network interface communicatively coupled to the IPsec virtual gateway 312, 314. In such examples, the first IPsec virtual gateway 312 is configured to route traffic to/from the CU-CP VNF 306 and the CU-UP VNF 308 using the IPv4 address for the CU-CP VNF 306 and the CU-UP VNF 308, and the second IPsec virtual gateway 314 is configured to route traffic to/from the DU VNF 310 using the IPv4 address for the DU VNF 310.

In some examples, the traffic routed to/from the CU-CP VNF 306 and CU-UP VNF 308 via the first IPsec virtual gateway 312 is the same type of traffic (for example, O1 traffic from a service management network). In other examples, the traffic routed to the CU-CP VNF 306 is a different type of traffic than the traffic routed to the CU-UP VNF 308 via the first IPsec virtual gateway 312. In one such example, the IPsec virtual gateway 312 is configured to communicate traffic with a mobile core network, route X2-C traffic transmitted using the IPsec tunnel 316 to the CU-CP VNF 306, and route X2-U/S1-U traffic transmitted using the IPsec tunnel 316 to the CU-UP VNF 308. In another such example, the IPsec virtual gateway 312 is configured to communicate traffic with a 5G mobile core network, route Xn-C/N2 traffic transmitted using the IPsec tunnel 316 to the CU-CP VNF 306, and route Xn-U/N3 traffic transmitted using the IPsec tunnel 316 to the CU-UP VNF 308.

In either case, when multiple VNFs (for example, CU-CP VNF 306 and CU-UP VNF 308) are connecting to the same external network 322, an IPsec virtual gateway 312 can be shared by those VNFs. In some examples, the VNFs are manually configured to utilize the same IPsec virtual gateway 312. In other examples, the VNFs and/or IPsec virtual gateway 312 utilize internal discovery capabilities to determine whether/when the VNFs will be configured to utilize the same IPsec virtual gateway 312.

While the CU node 302 and the DU node 304 are shown as including separate IPsec virtual gateways 312, 314, this may not be necessary if the CU node 302 and the DU node 304 are deployed on the same platform (for example, same server). In particular, if the CU node 302 (including the CU-CP VNF 306 and CU-UP VNF 308) and the DU node 304 (include the DU VNF(s) 310) are deployed on the same platform, then a single instance of an IPsec virtual gateway can be used for each respective traffic type. In such examples, the IPsec virtual gateway is configured to terminate the IPsec tunnel (including removing encapsulation) for a respective traffic type and route traffic to the CU-CP VNF 306, CU-UP VNF 308, and DU VNF 310 using the respective IP addresses for those entities. However, if the CU node 302 and the DU node 304 are deployed on different platforms (for example, different servers), then the separate IPsec virtual gateways 312, 314 are needed in order to prevent exposing the subnetwork of an application in an untrusted environment.

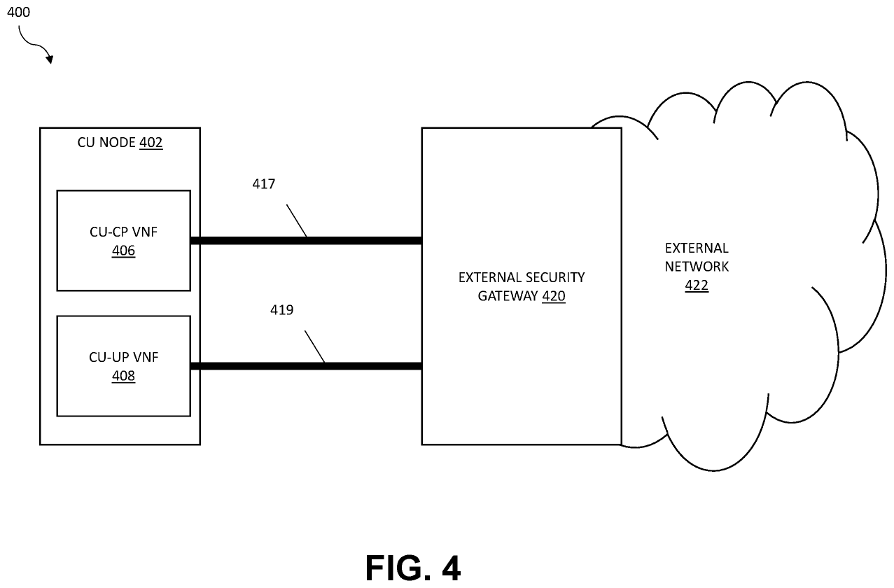

FIG. 4 illustrates a block diagram of example connections between a node of a virtualized gNB and an external network. In the example shown in FIG. 4, the CU node 402 of the gNB is communicatively coupled to an external network 422. While FIG. 4 specifically illustrates the CU node 402 of a virtualized gNB, it should be understood that the techniques described with respect to these features can also be implemented for any virtualized base station entity used to implement at least some functions for one or more layers of a wireless interface used to communicate with user equipment. While not explicitly shown in FIG. 4 for clarity, it should be understood that the CU node 402 of the virtualized gNB in FIG. 4 can be implemented using the scalable cloud platform and virtualization techniques described above. Further, while FIG. 4 illustrates VNFs specific to the CU node 402 (CU-CP VNF 406 and CU-UP VNF 408), it should be understood that the techniques described with respect to these features can also be implemented for other applications or VNFs implemented by a virtualized base station entity. Moreover, while FIG. 4 illustrates multiple VNFs specific to the CU node 402 (CU-CP VNF 406 and CU-UP VNF 408), it should be understood that other virtualized base station entities can implement one or more applications or VNFs and use similar techniques to those described below.

In the example shown in FIG. 4, the CU node 402 includes a CU-CP VNF 406 and a CU-UP VNF 408. In the example shown in FIG. 4, the CU-CP VNF 406 and the CU-UP VNF 408 are communicatively coupled to an external security gateway 420. In contrast to the connections in FIG. 3 that utilize an IPsec virtual gateway, the CU-CP VNF 406 and CU-UP VNF 408 are directly communicatively coupled to the external security gateway 420 using respective IPsec tunnels 417, 419, and the IPsec tunnels 417, 419 are terminated at the application layer. The first IPsec tunnel 417 is terminated by the CU-CP VNF 406 and the second IPsec tunnel 419 is terminated by the CU-UP VNF 408. The CU-CP VNF 406 and the CU-UP VNF 408 are each configured to respectively connect with the external security gateway 420 in a host-to-gateway mode.

In the example shown in FIG. 4, the CU-CP VNF 406 and the CU-UP VNF 408 each include respective IP addresses that are exposed to the external network 422. In some examples, the CU-CP VNF 406 and the CU-UP VNF 408 of the CU node 402 are deployed as microservices and have their own unique identity and IP address. In some examples, the CU-CP VNF 406 and the CU-UP VNF 408 each include a tunnel network interface (not shown) that, for incoming traffic, is configured to terminate the respective IPsec tunnel 417, 419 (including removing encapsulation) that has a first IP address (used as an outer IP address for IPsec tunnel traffic) and terminate the tunneled traffic internally at the VNF 406, 408 that has a second IP address (used as an inner IP address for IPsec tunnel traffic). For outgoing traffic, the tunnel network interface (not shown) for each respective VNF is configured to encapsulate the packets the respective VNF inside IPsec tunnel IP packets and transmit the IPsec tunnel IP packets to the external security gateway 420 via the respective IPsec tunnel 417, 419. In such examples, the respective tunnel network interfaces expose the IP addresses and identities of the elements for VNFs 406, 408 of the CU node 402 to the external network 422 in a manner similar to a host-to-site VPN model, and the external network 422 is able to communicate with each VNF 406, 408 of a node individually using the unique IP address for the respective VNF 406, 408.

In some examples, each application has a respective IP address for each type of traffic where an IPsec connection is used. In such examples, the access network interface and the tunnel network interface for each respective VNF 406, 408 are assigned a respective IP address for each type of traffic that is communicated to/from that VNF 406, 408. In some examples, the VNFs 406, 408 are assigned an IPv6 address (used as an inner IP address for IPsec tunnel traffic) and an IPv4 address for the tunnel network interface (used as an outer IP address for IPsec tunnel traffic). In other examples, the VNFs 406, 408 are assigned an IPv4 address (used as an inner IP address for IPsec tunnel traffic) and an IPv6 address for the tunnel network interface (used as an outer IP address for IPsec tunnel traffic).

The traffic communicated to the CU-CP VNF 406 via the first IPsec tunnel 417 is a different type of traffic than the traffic communicated to the CU-UP VNF 408 via the second IPsec tunnel 419. For example, the CU-CP VNF 406 is configured to communicate X2-C traffic via the first IPsec tunnel 417 with a mobile core network 422, and the CU-UP VNF 408 is configured to communicate X2-U/S1-U traffic via the second IPsec tunnel 419 with the mobile core network 422. In another example, the CU-CP VNF 406 is configured to communicate Xn-C/N2 traffic via the first IPsec tunnel 417 with a mobile core network 422, and the CU-UP VNF 408 is configured to communicate Xn-U/N3 traffic via the second IPsec tunnel 419 with the mobile core network 422.

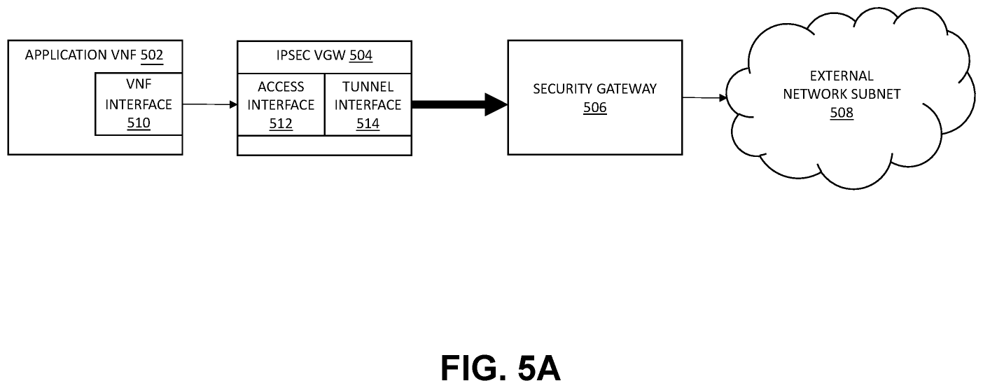

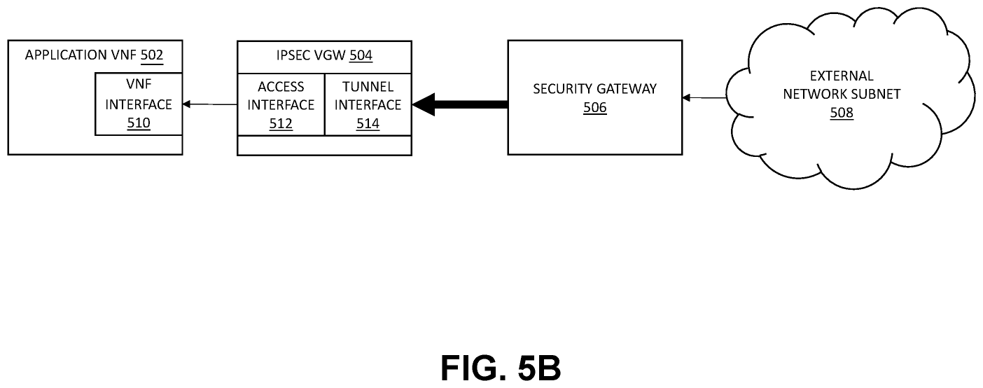

FIGS. 5A-5B illustrate an example of outgoing and incoming traffic flows for an IPsec virtual gateway (for example, IPsec virtual gateway 312, 314, 612, 613, 614). It should be understood that the IPsec virtual gateway can be used for communicating and routing any type of traffic for a virtualized 5G gNB. For example, an IPsec virtual gateway can be used to routing O1 traffic, O2 traffic, X2-C traffic, X2-U/S1-U traffic, F1-C traffic, F1-U traffic, N2 traffic, N3 traffic, Xn-C traffic, Xn-U traffic, or other types of traffic utilized for a virtualized 5G gNB or other base station. While not explicitly shown in FIG. 5 for clarity, it should be understood that the application VNF 502 and the IPsec virtual gateway 504 in FIG. 5 can be implemented using the scalable cloud platform and virtualization techniques described above.

The example shown in FIG. 5A illustrates outgoing traffic from an application VNF 502 being provided to an external network 508 via the IPsec virtual gateway 504. In the example shown in FIG. 5A, the application VNF 502 (for example, CU-CP VNF, CU-UP VNF, or DU VNF) includes a network interface 510 and is configured to transmit IP packets to an access network interface 512 of the IPsec virtual gateway 504. The IPsec virtual gateway 504 is configured to transparently encapsulate the IP packets from the application VNF 502 into the IPsec tunnel IP packets and transmit the IPsec tunnel IP packets via the tunnel network interface 514 using an IPsec tunnel. The IPsec tunnel IP packets, which include the encapsulated IP packets from the application VNF 502, are received at the security gateway 506 of the external network, and the security gateway is configured to remove the encapsulation of the IP packets. The security gateway 506 is also configured to route/deliver the IP packets to a network interface of an end point (for example, an OAM or DMS) in the external network subnet using the IP address of the end point.

The example shown in FIG. 5B illustrates incoming traffic from an external network 508 being provided to an application VNF 502 via the IPsec virtual gateway 504. In the example shown in FIG. 5B, the endpoint of an external network 508 is configured to transmit IP packets to the security gateway 506. The security gateway 506 is configured to transparently encapsulate the IP packets from the endpoint of the external network 508 into the IPsec tunnel IP packets and transmit the IPsec tunnel IP packets to the IPsec virtual gateway 504 using an IPsec tunnel and the IP address of the tunnel network interface 514 (used as an outer IP address for IPsec tunnel traffic). The IPsec tunnel IP packets, which include the encapsulated IP packets from the endpoint of the external network 508, are received at the tunnel network interface 514 of the IPsec virtual gateway 504, and the IPsec virtual gateway 504 is configured to remove the encapsulation of the IP packets. The IPsec virtual gateway 504 is also configured to route/deliver the IP packets to the network interface 510 of the application VNF 502 (for example, CU-CP VNF, CU-UP VNF, or DU VNF) using the IP address of the network interface 510 of the application VNF 502 (used as an inner IP address for IPsec tunnel traffic).

In some examples, the network interface 510 of the application VNF 502 is assigned an IPv6 address (inner IP address), the IPsec virtual gateway 504 is assigned an IPv6 address as the gateway IP address of the subnetwork, and the tunnel network interface 514 of the IPsec virtual gateway is assigned an IPv4 address (outer IP address). In such examples, the security gateway 506 is assigned an IPv4 address (outer IP address) and the end points in the external network subnet are assigned IPv6 addresses (inner IP address).

In other examples, the network interface 510 of the application VNF 502 is assigned an IPv4 address (inner IP address), the IPsec virtual gateway 504 is assigned an IPv4 address as the gateway IP address of the subnetwork, and the tunnel network interface 514 of the IPsec virtual gateway is assigned an IPv6 address (outer IP address). In such examples, the security gateway 506 is assigned an IPv6 address (outer IP address) and the end points in the external network subnet are assigned IPv4 addresses (inner IP address).

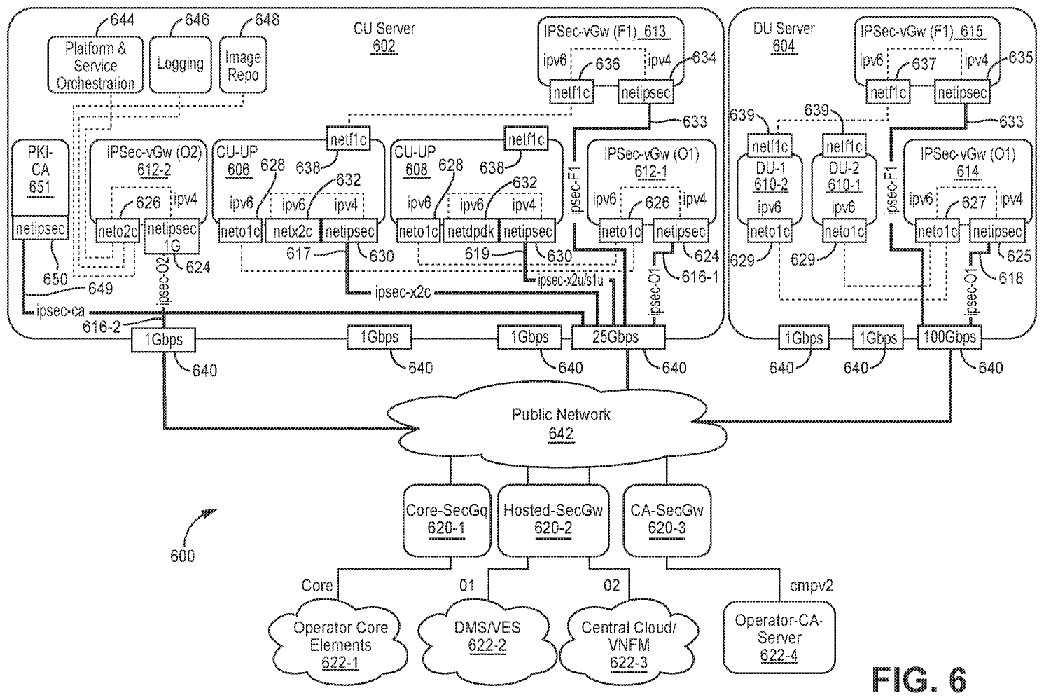

FIG. 6 illustrates a block diagram of an example virtualized gNB and various networks. In the example shown in FIG. 6, the virtualized gNB includes a CU server node 602 and a DU server node 604 that are communicatively coupled to external networks 622 using the IPsec tunnel techniques described above with respect to FIGS. 3-5. In the example shown in FIG. 6, the CU node 602 and DU node 602 are coupled to external networks 622 through a public network 642 using particular trunk connections 640. It should be understood that the virtualized gNB shown in FIG. 6 represents a specific example implementation and other implementations are possible and covered by the present disclosure. Further, while not explicitly shown in FIG. 6 for clarity, it should be understood that the components of the CU node 602 and DU node 604 in FIG. 6 can be implemented using the scalable cloud platform and virtualization techniques described above.

In the example shown in FIG. 6, the CU node 602 includes a CU-CP VNF 606, a CU-UP VNF 608, and multiple IPsec virtual gateways 612. In the example shown in FIG. 6, the CU node 602 also includes a platform and service orchestration function 644, logging services 646, and a VNF image repository 648. In the example shown in FIG. 6, the CU node 602 also includes a public-key infrastructure (PKI) certificate authority (CA) application 651. In some examples, these features of the CU node 602 are deployed as microservices in the CU node 602.

The CU node 602 of a virtualized gNB will always include at least one CU-CP VNF 606 and at least one CU-UP VNF 608, but the other components of the virtualized gNB shown in FIG. 6 are implementation specific. It should be understood that the particular number of IPsec virtual gateways 612, 613 in the CU node 602 and the elements of the CU node 602 can vary depending on the requirements for the virtualized gNB 600.

In the example shown in FIG. 6, the CU-CP VNF 606 and the CU-UP VNF 608 are communicatively coupled to an external network 622-2 via the first IPsec virtual gateway 612-1. The CU-CP VNF 606 and CU-UP VNF 608 are configured to communicate data with a service management network 622-2 using an IPsec tunnel 616-1 between the first IPsec virtual gateway 612-1 in the CU node 602 and a security gateway 620-2 of the service management network 622-2. In some examples, the CU-CP VNF 606 and the CU-UP VNF 608 are configured to communicate O1 traffic with an Operations and Maintenance (OAM) entity or Device Management System (DMS) via the first IPsec virtual gateway 612-1 in a manner similar to that described above with respect to FIGS. 3 and 5. In particular, the first IPsec virtual gateway 612-1 includes a tunnel network interface 624 and an access network interface 626 and is configured to route O1 traffic to/from the network interfaces 628 of the CU-CP VNF 606 and the CU-UP VNF 608. The first IPsec virtual gateway 612-1 is configured to terminate the IPsec tunnel 616-1 (including removing encapsulation) for incoming traffic, and the first IPsec virtual gateway 612-1 is configured to encapsulate packets from the CU-CP VNF 606 and CU-UP VNF 608 and transmit them to the security gateway 620-2 using the IPsec tunnel 616-1 for outgoing traffic.

In the example shown in FIG. 6, the CU-CP VNF 606 and the CU-UP VNF 608 are also communicatively coupled to another external network 622-1. The CU-CP VNF 606 and the CU-UP VNF 608 are configured to communicate data with a mobile network 622-1 (for example, operator core network) via the respective IPsec tunnels 617, 619 with the security gateway 620-1 of the mobile network 622-1. In some examples, the CU-CP VNF 606 is configured to communicate X2-C traffic with the operator core network 622-1 using an IPsec tunnel 617 and the CU-UP VNF 608 is configured to communicate X2-U/S1-U traffic with the operator core network 622-1 using a different IPsec tunnel 619. The CU-CP VNF 606 and the CU-UP VNF 608 are configured to implement IPsec client functions within the CU-CP VNF 606 and the CU-UP VNF 608 to terminate the respective IPsec tunnels 617, 619 in a manner similar to that described above with respect to FIG. 4. In particular, the CU-CP 606 and the CU-UP VNF 608 each include a tunnel network interface 630 and second IP address configured in a manner similar to that described above with respect to FIG. 4. In other examples, an IPsec virtual gateway could include a tunnel network interface and an access network interface and be configured to route the X2/S1 (or Xn/N2/N3 for a 5GC) traffic to/from the network interfaces 632 of the CU-CP VNF 606 and the CU-UP VNF 608.

In the example shown in FIG. 6, the platform and service orchestration function 644, logging services 646, and VNF image repository 648 are communicatively coupled to an external network 622-3 via a second IPsec virtual gateway 612-2. The platform and service orchestration function 644, logging services 646, and VNF image repository 648 are configured to communicate data with a platform or service orchestration network using an IPsec tunnel 616-2 between the second IPsec virtual gateway 612-2 in the CU node 602 and a security gateway 620-2 of the platform or service orchestration network 622-3. In some examples, the platform and service orchestration function 644, logging services 646, and VNF image repository 648 of the CU node 602 are configured to communicate O2 traffic with a virtual network function manager (VNFM) or REC controller of a platform or service orchestration network 622-3 via the second IPsec virtual gateway 612-2 in a manner similar to that described above with respect to FIGS. 3 and 5. In particular, the second IPsec virtual gateway 612-2 includes a tunnel network interface 624 and an access network interface 626 and is configured to route O2 traffic to/from the platform and service orchestration function 644, logging services 646, and VNF image repository 648 of the CU node 602. The second IPsec virtual gateway 612-2 is configured to terminate the IPsec tunnel 616-2 (including removing encapsulation) for incoming traffic, and the second IPsec virtual gateway 612-2 is configured to encapsulate packets from the platform and service orchestration function 644, logging services 646, and VNF image repository 648 and transmit them to the security gateway 620-2 using the IPsec tunnel 616-2.

In the example shown in FIG. 6, the CU-CP VNF 606 and the CU-UP VNF 608 are also communicatively coupled to the DU VNFs 610 via the third IPsec virtual gateway 613 in the CU node 602. The CU-CP VNF 606 is configured to communicate control-plane data and the CU-UP VNF 608 configured to communicate user-plane data with the DU VNFs 610 using an IPsec tunnel 633 between the third IPsec virtual gateway 613 in the CU node 602 and an IPsec virtual gateway 615 of the DU node 604. In some examples, the CU-CP VNF 606 is configured to communicate F1-C traffic with the DU VNFs 610 and the CU-UP VNF 608 is configured to communicate F1-U traffic with the DU VNFs 610 via the third IPsec virtual gateway 613. In particular, the third IPsec virtual gateway 613 includes a tunnel network interface 634 and an access network interface 636 and is configured to route the F1 traffic to/from the network interfaces 638 of the CU-CP VNF 606 and the CU-UP VNF 608. The third IPsec virtual gateway 613 is configured to terminate the IPsec tunnel 633 (including removing encapsulation) for incoming traffic, and the third IPsec virtual gateway 613 is configured to encapsulate packets from the CU-CP VNF 606 and CU-UP VNF 608 and transmit them to the IPsec virtual gateway 615 using the IPsec tunnel 633 for outgoing traffic.

In the example shown in FIG. 6, the PKI-CA application 651 is communicatively coupled to an operator CA server 622-4 via an IPsec tunnel 649 between a tunnel network interface 650 and a security gateway 620-3 for the operator CA 622-4.

In the example shown in FIG. 6, the DU node 604 includes a first DU VNF instance 610-1, a second DU VNF instance 610-2, a first IPsec virtual gateway 614, and a second IPsec virtual gateway 615. In some examples, the DU VNF instances 610 and IPsec virtual gateways 614, 615 are deployed as microservices in the DU node 604.

In the example shown in FIG. 6, the first DU VNF instance 610-1 and the second DU VNF instance 610-2 are communicatively coupled to an external network 622-2 via the first IPsec virtual gateway 614 in the DU node 604. The DU VNF instances 610 are configured to communicate data with the service management network 622-2 using an IPsec tunnel 618 between the first IPsec virtual gateway 614 in the DU node 604 and a security gateway 620-2 of the service management network 622-2. In some examples, the DU VNF instances 610 are configured to communicate O1 traffic with an Operations and Maintenance (OAM) entity or Device Management System (DMS) via the first IPsec virtual gateway 614 in a manner similar to that described above with respect to FIGS. 3 and 5. In particular, the first IPsec virtual gateway 614 includes a tunnel network interface 625 and an access network interface 627 and is configured to route O1 traffic to/from the network interfaces 629 of the DU VNF instances 610. The first IPsec virtual gateway 614 is configured to terminate the IPsec tunnel 618 (including removing encapsulation) for incoming traffic, and the first IPsec virtual gateway 614 is configured to encapsulate packets from the DU VNF instances 610 and transmit them to the security gateway 620-2 using the IPsec tunnel 618 for outgoing traffic.

In the example shown in FIG. 6, the first DU VNF instance 610-1 and the second DU VNF instance 610-2 are communicatively coupled to the CU-CP VNF 606 and CU-UP VNF 608 via the second IPsec virtual gateway 615 in the DU node 604. The DU VNF instances 610 are configured to communicate control-plane data with the CU-CP VNF 606 and user-plane data with the CU-UP VNF 608 using an IPsec tunnel 633 between the third IPsec virtual gateway 613 in the CU node 602 and the second IPsec virtual gateway 615 of the DU node 604. In some examples, the DU VNF instances 610 are configured to communicate F1-C traffic with the CU-CP VNF 606 and F1-U traffic with the CU-UP VNF 608 via the second IPsec virtual gateway 615 in the DU node 604. In particular, the second IPsec virtual gateway 615 includes a tunnel network interface 635 and an access network interface 637 and is configured to route the F1 traffic to/from the network interfaces 639 of the DU VNF instances 610. The second IPsec virtual gateway 615 is configured to terminate the IPsec tunnel 633 (including removing encapsulation) for incoming traffic, and the second IPsec virtual gateway 615 is configured to encapsulate packets from the DU VNF instances 610 and transmit them to the IPsec virtual gateway 613 using the IPsec tunnel 633 for outgoing traffic.

In some examples, the virtualized gNBs described above can be deployed in a venue in conjunction with a Long-Term Evolution (LTE) Evolved NodeB (eNB). In some such examples, the LTE eNB is configured to communicate X2-C and X2-U/S1-U traffic with the security gateway of the mobile network using IPsec tunnels. In some examples, the LTE eNB can be implemented using virtualization techniques similar to those described above with respect to the virtualized gNBs. In such examples, the IPsec techniques described above with respect to FIGS. 3-5 could be utilized in a similar manner for the virtualized eNB.

Other examples are implemented in other ways.

The systems and methods described herein provide flexible solutions for ensuring network security for virtualized base stations. The systems and methods described herein reduce the exposure or vulnerability of the operator network and enable compliance with operator network topology restrictions and implementation of the virtualized base station even with limited operator IPsec resource availability.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### Example Embodiments

Example 1 includes a system to provide wireless service to user equipment, the system comprising: a scalable cloud environment configured to implement: a base station using a plurality of virtualized base station entities, wherein each virtualized base station entity of the plurality of virtualized base station entities is configured to implement at least some functions for one or more layers of a wireless interface used to communicate with user equipment; and a first Internet Protocol Security (IPsec) virtual gateway configured to be communicatively coupled to an external network, wherein the first IPsec virtual gateway is configured to terminate an IPsec tunnel with the external network, wherein the first IPsec virtual gateway is configured to route traffic from the external network to at least one application implemented by a first virtualized base station entity of the plurality of virtualized entities.

Example 2 includes the system of Example 1, wherein the plurality of virtualized base station entities include: a central unit (CU), wherein the CU is configured to implement at least one CU-control-plane (CU-CP) virtual network function and at least one CU-user-plane (CU-UP) virtual network function; and a distributed unit (DU) served by the CU, wherein the DU is configured to serve at least some of the user equipment, wherein the DU is configured to implement at least one DU virtual network function.

Example 3 includes the system of Example 2, wherein the system comprises one or more radio units (RUs), each RU is communicatively coupled to the DU and is associated with a respective set of one or more antennas via which downlink radio frequency signals are radiated to at least some of the user equipment and via which uplink radio frequency signals transmitted by at least some of the user equipment are received.

Example 4 includes the system of any of Examples 1-3, wherein the first IPsec virtual gateway is communicatively coupled to at least one virtual network function implemented by the first virtualized base station entity, wherein the first IPsec virtual gateway is configured to route traffic from the external network to the at least one virtual network function.

Example 5 includes the system of any of Examples 1-4, wherein the first IPsec virtual gateway is communicatively coupled to a first virtual network function implemented by the first virtualized base station entity and a second virtual network function implemented by the first virtualized base station entity, wherein the traffic routed to the first virtual network function by the first IPsec virtual gateway is a different type of traffic compared to the traffic routed to the second virtual network function by the first IPsec virtual gateway.

Example 6 includes the system of any of Examples 1-5, wherein a first virtual network function implemented by the first virtualized base station entity is configured to terminate a first IPsec tunnel between the first virtual network function and a second network.

Example 7 includes the system of any of Examples 1-6, wherein the traffic includes one of: O1 traffic from a service management network; O2 traffic from a platform or service orchestration network; X2/S1 traffic from a first mobile core network; or Xn/N2/N3 traffic from a second mobile core network.

Example 8 includes the system of any of Examples 1-7, wherein the scalable cloud environment is further configured to implement a second virtualized base station entity of the plurality of virtualized base station entities; wherein the first virtualized base station entity is configured to implement a second IPsec virtual gateway and the second virtualized base station entity is configured to implement a third IPsec virtual gateway, wherein the second IPsec virtual gateway is communicatively coupled to the third IPsec virtual gateway, wherein the second IPsec virtual gateway and the third IPsec virtual gateway are configured to terminate an IPsec tunnel between the first virtualized base station entity and the second virtualized base station entity, wherein the first virtualized base station entity and the second virtualized base station entity are configured to communicate traffic via the second IPsec virtual gateway and the third IPsec virtual gateway.

Example 9 includes the system of any of Examples 1-8, further comprising an Evolved Node B (eNB) communicatively coupled to the external network, wherein the scalable cloud environment is configured to implement the eNB, wherein the eNB is configured to implement an IPsec virtual gateway configured to be communicatively coupled to a core network of an operator.

Example 10 includes a server, comprising: an Internet Protocol Security (IPsec) virtual gateway configured to be communicatively coupled to an external network; and at least one application virtual network function of a first virtualized base station entity, wherein the at least one application virtual network function is communicatively coupled to the IPsec virtual gateway via an internal network, wherein the first virtualized base station entity is configured to implement at least some functions for one or more layers of a wireless interface used to communicate with user equipment; wherein the IPsec virtual gateway is configured to terminate an IPsec tunnel with the external network, wherein the IPsec virtual gateway is configured to route traffic from the external network to the at least one application virtual network function of the first virtualized base station entity.

Example 11 includes the server of Example 10, wherein the internal network is an IP network.

Example 12 includes the server of any of Examples 10-11, wherein the at least one application virtual network function includes a first virtual network function and a second virtual network function, wherein the first virtual network function is configured to terminate a first IPsec tunnel between the first virtual network function and a second network, wherein the second virtual network function is configured to terminate a second IPsec tunnel between the second virtual network function and the second network.

Example 13 includes the server of any of Examples 10-12, wherein the server comprises a second IPsec virtual gateway, wherein the second IPsec virtual gateway is configured to terminate an IPsec tunnel between the first virtualized base station entity and a second virtualized base station entity configured to implement at least some functions for one or more layers of the wireless interface used to communicate with user equipment, wherein the first virtualized base station entity is configured to communicate traffic with the second virtualized base station entity via the second IPsec virtual gateway.

Example 14 includes the server of any of Examples 10-13, wherein the traffic includes one of: O1 traffic from a service management network; O2 traffic from a platform or service orchestration network; X2/S1 traffic from a first mobile core network; or Xn/N2/N3 traffic from a second mobile core network.

Example 15 includes a method of providing wireless service to user equipment, the method comprising: using a scalable cloud environment configured to implement: a base station using a plurality of virtualized entities, wherein each virtualized entity of the plurality of virtualized entities is configured to implement at least some functions for one or more layers of a wireless interface used to communicate with user equipment; and a first Internet Protocol Security (IPsec) virtual gateway configured to be communicatively coupled to an external network, wherein the first IPsec virtual gateway is configured to terminate an IPsec tunnel with the external network, wherein the first IPsec virtual gateway is configured to route traffic from the external network to at least one application implemented by a first virtualized entity of the plurality of virtualized entities.

Example 16 includes the method of Example 15, wherein the plurality of virtualized entities include: a central unit (CU), wherein the CU is configured to implement at least one CU-control-plane (CU-CP) virtual network function and at least one CU-user-plane (CU-UP) virtual network function; and a distributed unit (DU) served by the CU, wherein the DU is configured to serve at least some of the user equipment, wherein the DU is configured to implement at least one DU virtual network function.

Example 17 includes the method of any of Examples 15-16, wherein the first IPsec virtual gateway is communicatively coupled to at least one virtual network function implemented by the first virtualized entity, wherein the first IPsec virtual gateway is configured to route traffic from the external network to the at least one virtual network function.

Example 18 includes the method of any of Examples 15-17, wherein the first IPsec virtual gateway is communicatively coupled to a first virtual network function and a second virtual network function, wherein the traffic routed to the first virtual network function by the first IPsec virtual gateway is a different type of traffic compared to the traffic routed to the second virtual network function by the first IPsec virtual gateway.

Example 19 includes the method of any of Examples 15-18, wherein the first IPsec virtual gateway is communicatively coupled to at least one virtual network function implemented by the first virtualized entity, wherein the at least one virtual network function is configured to terminate a first IPsec tunnel between the at least one virtual network function and a second network.

Example 20 includes the method of any of Examples 15-19, wherein the scalable cloud environment is further configured to implement a second IPsec virtual gateway configured to be communicatively coupled to a second external network or a second virtualized entity of the plurality of virtualized entities, wherein the second IPsec virtual gateway is configured to terminate an IPsec tunnel with the second external network or the second virtualized entity of the plurality of virtualized entities, wherein the first IPsec virtual gateway is configured to route traffic from the external network or the second virtualized entity of the plurality of virtualized entities to at least one application implemented by the first virtualized entity of the plurality of virtualized entities.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system to provide wireless service to user equipment, the system comprising:
a scalable cloud environment configured to implement:
a base station using a plurality of virtualized base station entities, wherein each virtualized base station entity of the plurality of virtualized base station entities is configured to implement at least some functions for one or more layers of a wireless interface used to communicate with user equipment; and
a first Internet Protocol Security (IPsec) virtual gateway configured to be communicatively coupled to an external network, wherein the first IPsec virtual gateway is configured to terminate an IPsec tunnel with the external network, wherein the first IPsec virtual gateway is configured to route traffic from the external network to at least one application implemented by a first virtualized base station entity of the plurality of virtualized entities.

2. The system of claim 1, wherein the plurality of virtualized base station entities include:
a central unit (CU), wherein the CU is configured to implement at least one CU-control-plane (CU-CP) virtual network function and at least one CU-user-plane (CU-UP) virtual network function; and
a distributed unit (DU) served by the CU, wherein the DU is configured to serve at least some of the user equipment, wherein the DU is configured to implement at least one DU virtual network function.

3. The system of claim 2, wherein the system comprises one or more radio units (RUs), each RU is communicatively coupled to the DU and is associated with a respective set of one or more antennas via which downlink radio frequency signals are radiated to at least some of the user equipment and via which uplink radio frequency signals transmitted by at least some of the user equipment are received.

4. The system of claim 1, wherein the first IPsec virtual gateway is communicatively coupled to at least one virtual network function implemented by the first virtualized base station entity, wherein the first IPsec virtual gateway is configured to route traffic from the external network to the at least one virtual network function.

5. The system of claim 1, wherein the first IPsec virtual gateway is communicatively coupled to a first virtual network function implemented by the first virtualized base station entity and a second virtual network function implemented by the first virtualized base station entity, wherein the traffic routed to the first virtual network function by the first IPsec virtual gateway is a different type of traffic compared to the traffic routed to the second virtual network function by the first IPsec virtual gateway.

6. The system of claim 1, wherein a first virtual network function implemented by the first virtualized base station entity is configured to terminate a first IPsec tunnel between the first virtual network function and a second network.

7. The system of claim 1, wherein the traffic includes one of:
O1 traffic from a service management network;
O2 traffic from a platform or service orchestration network;
X2/S1 traffic from a first mobile core network; or
Xn/N2/N3 traffic from a second mobile core network.

8. The system of claim 1, wherein the scalable cloud environment is further configured to implement a second virtualized base station entity of the plurality of virtualized base station entities;
wherein the first virtualized base station entity is configured to implement a second IPsec virtual gateway and the second virtualized base station entity is configured to implement a third IPsec virtual gateway, wherein the second IPsec virtual gateway is communicatively coupled to the third IPsec virtual gateway, wherein the second IPsec virtual gateway and the third IPsec virtual gateway are configured to terminate an IPsec tunnel between the first virtualized base station entity and the second virtualized base station entity, wherein the first virtualized base station entity and the second virtualized base station entity are configured to communicate traffic via the second IPsec virtual gateway and the third IPsec virtual gateway.

9. The system of claim 1, further comprising an Evolved Node B (eNB) communicatively coupled to the external network, wherein the scalable cloud environment is configured to implement the eNB, wherein the eNB is configured to implement an IPsec virtual gateway configured to be communicatively coupled to a core network of an operator.

10. A server, comprising:
an Internet Protocol Security (IPsec) virtual gateway configured to be communicatively coupled to an external network; and
at least one application virtual network function of a first virtualized base station entity, wherein the at least one application virtual network function is communicatively coupled to the IPsec virtual gateway via an internal network, wherein the first virtualized base station entity is configured to implement at least some functions for one or more layers of a wireless interface used to communicate with user equipment;
wherein the IPsec virtual gateway is configured to terminate an IPsec tunnel with the external network, wherein the IPsec virtual gateway is configured to route traffic from the external network to the at least one application virtual network function of the first virtualized base station entity.

11. The server of claim 10, wherein the internal network is an IP network.

12. The server of claim 10, wherein the at least one application virtual network function includes a first virtual network function and a second virtual network function, wherein the first virtual network function is configured to terminate a first IPsec tunnel between the first virtual network function and a second network, wherein the second virtual network function is configured to terminate a second IPsec tunnel between the second virtual network function and the second network.

13. The server of claim 10, wherein the server comprises a second IPsec virtual gateway, wherein the second IPsec virtual gateway is configured to terminate an IPsec tunnel between the first virtualized base station entity and a second virtualized base station entity configured to implement at least some functions for one or more layers of the wireless interface used to communicate with user equipment, wherein the first virtualized base station entity is configured to communicate traffic with the second virtualized base station entity via the second IPsec virtual gateway.

14. The server of claim 10, wherein the traffic includes one of:
O1 traffic from a service management network;
O2 traffic from a platform or service orchestration network;
X2/S1 traffic from a first mobile core network; or
Xn/N2/N3 traffic from a second mobile core network.

15. A method of providing wireless service to user equipment, the method comprising:
using a scalable cloud environment configured to implement:
a base station using a plurality of virtualized entities, wherein each virtualized entity of the plurality of virtualized entities is configured to implement at least some functions for one or more layers of a wireless interface used to communicate with user equipment; and
a first Internet Protocol Security (IPsec) virtual gateway configured to be communicatively coupled to an external network, wherein the first IPsec virtual gateway is configured to terminate an IPsec tunnel with the external network, wherein the first IPsec virtual gateway is configured to route traffic from the external network to at least one application implemented by a first virtualized entity of the plurality of virtualized entities.

16. The method of claim 15, wherein the plurality of virtualized entities include:
a central unit (CU), wherein the CU is configured to implement at least one CU-control-plane (CU-CP) virtual network function and at least one CU-user-plane (CU-UP) virtual network function; and
a distributed unit (DU) served by the CU, wherein the DU is configured to serve at least some of the user equipment, wherein the DU is configured to implement at least one DU virtual network function.

17. The method of claim 15, wherein the first IPsec virtual gateway is communicatively coupled to at least one virtual network function implemented by the first virtualized entity, wherein the first IPsec virtual gateway is configured to route traffic from the external network to the at least one virtual network function.

18. The method of claim 15, wherein the first IPsec virtual gateway is communicatively coupled to a first virtual network function and a second virtual network function, wherein the traffic routed to the first virtual network function by the first IPsec virtual gateway is a different type of traffic compared to the traffic routed to the second virtual network function by the first IPsec virtual gateway.

19. The method of claim 15, wherein the first IPsec virtual gateway is communicatively coupled to at least one virtual network function implemented by the first virtualized entity, wherein the at least one virtual network function is configured to terminate a first IPsec tunnel between the at least one virtual network function and a second network.

20. The method of claim 15, wherein the scalable cloud environment is further configured to implement a second IPsec virtual gateway configured to be communicatively coupled to a second external network or a second virtualized entity of the plurality of virtualized entities, wherein the second IPsec virtual gateway is configured to terminate an IPsec tunnel with the second external network or the second virtualized entity of the plurality of virtualized entities, wherein the first IPsec virtual gateway is configured to route traffic from the external network or the second virtualized entity of the plurality of virtualized entities to at least one application implemented by the first virtualized entity of the plurality of virtualized entities.
